(19) United States
(12) Patent Application Publication
(10) Pub. No.: US 2014/0063425 A1
(43) Pub. Date: Mar. 6, 2014

(54) LIQUID CRYSTAL DISPLAY PANEL AND LIQUID CRYSTAL DISPLAY APPARATUS

(71) Applicant: InnoLux Corporation, Jhu-Nan (TW)

(72) Inventors: Yun-Chun LIOU, Jhu-Nan (TW); Heng-Yi CHANG, Jhu-Nan (TW); Ying-Ting CHEN, Jhu-Nan (TW); Wan-Ling HUANG, Jhu-Nan (TW); Wei-Chuan HUANG, Jhu-Nan (TW); Hung-Tse LIN, Jhu-Nan (TW); Chao-Lung CHIN, Jhu-Nan (TW); Kai-Neng YANG, Jhu-Nan (TW); Tsau-Hua HSIEH, Jhu-Nan (TW)

(73) Assignee: InnoLux Corporation, Jhu-Nan (TW)

(21) Appl. No.: 14/015,625

(22) Filed: Aug. 30, 2013

(30) Foreign Application Priority Data
Sep. 3, 2012 (TW) 101131996

(51) Int. Cl. G02F 1/1337

(52) U.S. Cl. CPC G02F 1/133711; G02F 1/13378
USPC 349/124

(57) ABSTRACT

A liquid crystal display (LCD) panel includes a first substrate, a second substrate and a liquid crystal layer. The first substrate includes a first rubbing alignment layer and a first photo-induced polymer alignment layer. The second substrate is disposed opposite to the first substrate, and includes a second photo-induced polymer alignment layer. The liquid crystal layer is disposed between the first and second substrates, and contacts the photo-induced polymer alignment layers.

### CROSS REFERENCE TO RELATED APPLICATIONS

This Non-provisional application claims priority under 35 U.S.C. §119(a) on Patent Application No(s). 101131996 filed in Taiwan, Republic of China on Sep. 3, 2012, the entire contents of which are hereby incorporated by reference.

### BACKGROUND

1. Technical Field

The disclosed embodiments relate to a display panel and a display apparatus and, in particular, to a liquid crystal display panel and a liquid crystal display apparatus.

2. Related Art

The liquid crystal (LC) alignment is one of the key technologies to determine the display quality of a liquid crystal display (LCD) apparatus. Only when the liquid crystal material has a stable and even initial arrangement, can the high quality images be displayed. In general, a thin film disposed in the liquid crystal panel for inducing the liquid crystal molecules' arrangement is called a liquid crystal alignment layer.

For the manufacturing process, a rubbing method is often used for arranging liquid crystal molecules evenly. In the rubbing method, a polyimide layer, for example, undergoes a mechanical rubbing to generate a plurality of micro-grooves disposed in parallel, which can result in the arrangement of liquid crystal molecules.

However, the LC alignment layer formed by the rubbing method will easily make the display panel have the mura problem that will decrease the production yield. Besides, the rubbing method also leads to the problem of image sticking.

Therefore, it is an important subject to provide an LCD panel and an LCD apparatus that can solve the problems caused by the rubbing method so that the production yield and display quality can be enhanced.

### SUMMARY

In view of the foregoing subject, an objective of the disclosed embodiments of this disclosure is to provide an LCD panel and an LCD apparatus that can solve the problems caused by the rubbing method.

To achieve the above objective, a liquid crystal display (LCD) panel according to the embodiments of this disclosure includes a first substrate, a second substrate and a liquid crystal layer. The first substrate includes a first rubbing alignment layer and a first photo-induced polymer alignment layer. The second substrate is disposed opposite to the first substrate, and includes a second photo-induced polymer alignment layer. The liquid crystal layer is disposed between the first and second substrates, and contacts the first photo-induced polymer alignment layer and the second photo-induced polymer alignment layer.

In one embodiment, the first rubbing alignment layer includes polyimide as material.

In one embodiment, the first photo-induced polymer alignment layer is disposed between the liquid crystal layer and the first rubbing alignment layer.

In one embodiment, the liquid crystal display panel is of a fringe field switching (FFS) type, an in-plane switching (IPS) type, or a vertical alignment (VA) type.

In one embodiment, the first and second photo-induced polymer alignment layers are both formed by the polymerization of a plurality of monomers.

In one embodiment, the monomers include bi-acrylic monomers, tri-arcylic monomers or their combination.

In one embodiment, the monomers include 4,4′-bisacryloyl-biphenyl group with a chemical structure as follows:

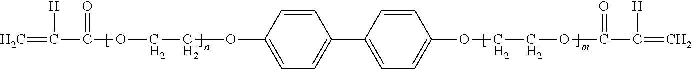

wherein, 0≦m≦5 and 0≦n≦5.

In one embodiment, the second substrate further includes a second rubbing alignment layer, and the second photo-induced polymer alignment layer is disposed between the liquid crystal layer and the second rubbing alignment layer.

In one embodiment, the second substrate further includes a polarization photo-alignment layer, and the second photo-induced polymer alignment layer is disposed between the liquid crystal layer and the polarization photo-alignment layer.

To achieve the above objective, a liquid crystal display panel according to the embodiments of this disclosure comprises a first substrate, a second substrate and a liquid crystal layer. The first substrate has a first photo-induced polymer alignment layer formed by the polymerization of a plurality of monomers. The second substrate is disposed opposite to the first substrate and has a second photo-induced polymer alignment layer formed by the polymerization of a plurality of monomers. The liquid crystal layer is disposed between the first and second substrates and contacts the first photo-induced polymer alignment layer and the second photo-induced polymer alignment layer. The monomers include 4,4′-bisacryloyl-biphenyl group with a chemical structure as follows:

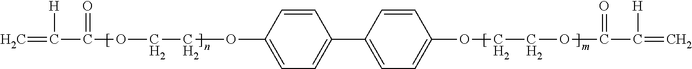

wherein, 0≦m≦5 and 0≦n≦5.

In one embodiment, the first substrate further includes a first rubbing alignment layer, and the first photo-induced polymer alignment layer is disposed between the liquid crystal layer and the first rubbing alignment layer.

In one embodiment, the first substrate further includes a first polarization photo-alignment layer, and the first photo-induced polymer alignment layer is disposed between the liquid crystal layer and the first polarization photo-alignment layer.

In one embodiment, the first rubbing alignment layer or the first polarization photo-alignment layer includes polyimide as material.

In one embodiment, the liquid crystal display panel is of a fringe field switching (FFS) type, an in-plane switching (IPS) type, or a vertical alignment (VA) type.

In one embodiment, the monomers include bi-acrylic monomers, tri-arcylic monomers or their combination.

In one embodiment, the second substrate further includes a second rubbing alignment layer, and the second photo-induced polymer alignment layer is disposed between the liquid crystal layer and the second rubbing alignment layer.

In one embodiment, the second substrate further includes a second polarization photo-alignment layer, and the second photo-induced polymer alignment layer is disposed between the liquid crystal layer and the second polarization photo-alignment layer.

To achieve the above objective, an LCD apparatus according to the embodiments of this disclosure includes a backlight module and any of the LCD panels as mentioned above. The LCD panel is disposed opposite to the backlight module.

As mentioned above, in the LCD panel and apparatus according to the embodiments of this disclosure, the first and second photo-induced polymer alignment layers are respectively disposed on the first and second substrates, and are formed by the polymerization of a plurality of monomers. These monomers can make an anchoring effect that can solve the problem of insufficient or unstable alignment of the rubbing alignment layer, so that the image sticking problem is further solved. Besides, the photo-induced polymer alignment layers also can reduce the light leakage problem caused by the rubbing alignment layer. Moreover, the rubbing alignment layer of this disclosure can be made with a slighter depth for the initial arrangement so that the rubbing mura can be reduced. Besides, a kind of monomer is also disclosed with the chemical structure as follows:

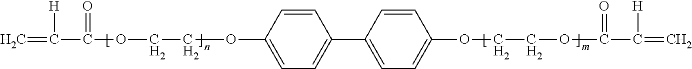

wherein, 0≦m≦5 and 0≦n≦5. This kind of monomer can enormously enhance the whole alignment efficiency.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a liquid crystal display panel according to a first embodiment of this disclosure;

FIG. 2 is a schematic diagram of an LCD panel as a variation according to the first embodiment of this disclosure;

FIG. 3 is a schematic diagram of a liquid crystal display panel according to a second embodiment of this disclosure;

FIG. 4 is a schematic diagram of LCD panel as a variation according to the second embodiment of this disclosure; and

FIG. 5 is a schematic diagram of a liquid crystal display apparatus according to an embodiment of this disclosure.

### DETAILED DESCRIPTION

The present invention will be apparent from the following detailed description, which proceeds with reference to the accompanying drawings, wherein the same references relate to the same elements.

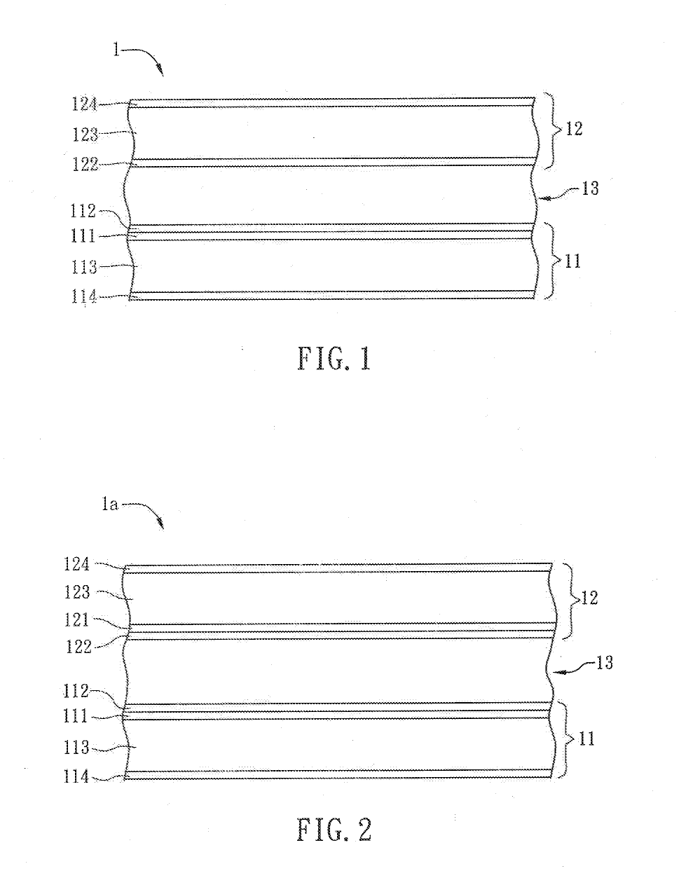

FIG. 1 is a schematic diagram of a liquid crystal display (LCD) panel 1 according to a first embodiment of this disclosure. In the embodiments of this disclosure, the LCD panel 1 is not limited in type, which can be a display panel of a fringe field switching (FFS) type, an in-plane switching (IPS) type, or a vertical alignment (VA) type, for example. The LCD panel 1 includes a first substrate 11, a second substrate 12 and a liquid crystal layer 13. The first and second substrates 11 and 12 are disposed oppositely, and the liquid crystal layer 13 is disposed between the first and second substrates 11 and 12. The first and second substrates 11 and 12 are the combination of a color filter (CF) substrate and a thin film transistor (TFT) substrate. Herein for example, the first substrate 11 is a thin film transistor substrate while the second substrate 12 is a color filter substrate. Besides, the LCD panel 1 can have variations according to other technologies. For example, the color filter layer can be disposed to the TFT substrate (i.e. color filter on array, COA), the color filter layer and the black matrix are both disposed to the TFT substrate (i.e. black matrix on array, BOA), or the TFT array is disposed on the CF substrate (i.e. TFT on CF, TOC or array on CF).

The first substrate 11 includes a first rubbing alignment layer 111 and a first photo-induced polymer alignment layer 112. Herein for example, the first rubbing alignment layer 111 includes polyimide (PI) as material, and is processed by a rubbing alignment process with at least an alignment direction. The said alignment directions can be the same or different. The first photo-induced polymer alignment layer 112 is formed by the polymerization of a plurality of monomers, and these monomers include, for example, bi-acrylic monomer, tri-arcylic monomer or their combination. The bi-acrylic monomer is, for example, 4,4′-bisacryloyl-biphenyl group, and the chemical structure thereof is as follows:

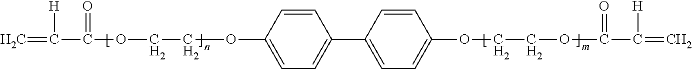

wherein, 0≦m≦5 and 0≦n≦5.

Moreover, the chemical structure of 4,4′-bisacryloyl-biphenyl group also can be as follows:

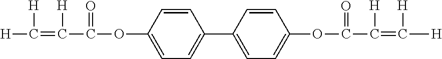 [SMILES: C=CC(=O)Oc1ccc(-c2ccc(OC(=O)C=C)cc2)cc1]

Otherwise, the chemical structure of 4,4′-bisacryloyl-biphenyl group also can be as follows:

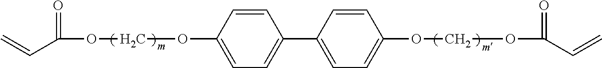

wherein, 1≦m≦7 and 1≦m′≦7.

Besides, the chemical name of bi-acrylic monomer also can be, for example, para-biacryl poly-phenyl group, and the chemical structure thereof is as follows:

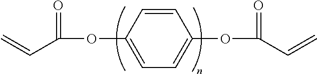

wherein, 1≦n≦5.

The tri-acrylic monomer is such as triacryl benzene, and the chemical structure thereof is as follows:

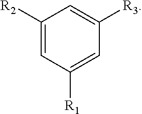

In the above chemical structure, R1=R2=R3=acrylic group, and the chemical structure of R3 is as follows:

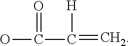

Besides, the first substrate 11 further includes a substrate body 113 and a polarizing element 114. With different types of the LCD panel 1 or applied technologies, the elements included by the substrate body 113 are varied. For example, the substrate body 113 can include a substrate, a TFT array, a pixel electrode layer, etc. The above-mentioned substrate can be a glass substrate, a tempered glass substrate, or a plastic substrate. The polarizing element 114 is attached to a side of the substrate body 113 away from the liquid crystal layer 13. The first rubbing alignment layer 111 and the first photo-induced polymer alignment layer 112 are disposed on a side of the substrate body 113 closer to the liquid crystal layer 13. The first photo-induced polymer alignment layer 112 is disposed between the first rubbing alignment layer 111 and the liquid crystal layer 13, and contacts the liquid crystal layer 13.

The second substrate 12 includes a second photo-induced polymer alignment layer 122. The second photo-induced polymer alignment layer 122 is formed by the polymerization of a plurality of monomers, and these monomers include, for example, bi-acrylic monomer, tri-arcylic monomer or their combination. Moreover, the second substrate 12 further includes a substrate body 123 and a polarizing element 124. With different types of the LCD panel 1 or applied technologies, the elements included by the substrate body 123 are varied. For example, the substrate body 123 can include a substrate, a black matrix, a color filter layer, a common electrode layer, etc. The above-mentioned substrate can be a glass substrate, a tempered glass substrate, or a plastic substrate. The polarizing element 124 is attached to a side of the substrate body 123 away from the liquid crystal layer 13. The second photo-induced polymer alignment layer 122 is disposed on a side of the substrate body 123 closer to the liquid crystal layer 13, and contacts the liquid crystal layer 13.

FIG. 2 is a schematic diagram of an LCD panel 1a as a variation according to this embodiment of this disclosure. In FIG. 2, the second substrate of the LCD panel 1a further includes a second rubbing alignment layer 121. Herein for example, the second rubbing alignment layer 121 includes polyimide as material, and is processed by a rubbing alignment process with at least an alignment direction. The said alignment directions can be the same or different. The second rubbing alignment layer 121 is disposed on a side of the substrate body 123 closer to the liquid crystal layer 13. The second photo-induced polymer alignment layer 122 is disposed between the second rubbing alignment layer 121 and the liquid crystal layer 13.

In other embodiments, the second rubbing alignment layer 121 can be replaced by a polarization photo-alignment layer. For the polarization photo-alignment layer, a polarized light (such as linear polarized ultraviolet) is used to illuminate a polyimide film, so that the molecular structure of the polyimide film reacts to generate directionally distributed Van der Waals force to achieve the alignment effect.

The manufacturing method of the LCD panel of this embodiment is illustrated as below by taking the LCD panel 1 as an example. First, the first and second substrates 11 and 12 attached and aligned to each other are provided, and a liquid crystal mixture is disposed therebetween. A first rubbing alignment layer 111 is disposed on the first substrate 11. The first rubbing alignment layer 111 is formed by the rubbing method wherein a roller is used to rub on a polymer film (such as a polyimide film). In this embodiment, the rotational speed of the roller is between 800 rpm and 1600 rpm, the depth is between 0.1 mm and 0.6 mm, and the moving speed of the substrate is between 10 mm/s and 100 mm/s, for example.

The liquid crystal mixture can be formed between the two substrates by the injection method or the one drop fill (ODF) method. The liquid crystal mixture includes a liquid crystal material and a plurality of monomers, and can further include a photoinitiator in other embodiments. The monomers include, for example, bi-acrylic monomer, tri-acrylic monomer, or their combination. The chemical structures of the monomers are clearly illustrated as above, and therefore they are not described here for concise purpose. The photoinitiator includes phenyl ketone, whose chemical name is such as 1-hydroxy-cyclohexylphenyl-ketone with the chemical structure as follows:

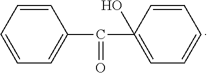

As an example, the monomers have a weight percentage between 0.1% and 1% in the liquid crystal mixture. Preferably, the monomers have a weight percentage between 0.2% and 0.5% in the liquid crystal mixture.

Then, when a vertical alignment LCD display is manufactured, an electric filed can be applied to the pixel electrode of the first substrate 11 and the common electrode of the second substrate 12 to tilt the liquid crystal to a required direction. At the same time of applying the electric filed, an illumination is also applied to at least one of the first substrate 11 and second substrate 12. When an LCD display panel of a fringe field switching (ITS) type or an in-plane switching (IPS) type is manufactured, an illumination is applied to at least one of the first substrate 11 and second substrate 12 while an electric field can not be applied to the pixel electrode of the first substrate 11 and the common electrode of the second substrate 12. The light source of the illumination can be an ultraviolet source with the wavelength between 200 nm and 400 nm and preferably between 300 nm and 380 nm. The illuminance of the ultraviolet source is between 0.1 mW and 30 mW and preferably between 5 mW and 20 mW. The illumination time is between 100 seconds and 2 hours, and the gross energy is between 0.5 J and 144 J, for example. Besides, the number and intensity of the illumination and those of applying the electric field are not limited in this embodiment.

The monomers will be polymerized by the illumination, and thus a first photo-induced alignment layer 112 and a second photo-induced alignment layer 122 are formed on the first substrate 11 and the second substrate 12, respectively. Besides, the liquid crystal mixture thus becomes a liquid crystal layer 13. To be noted, some monomers may remain in the liquid crystal layer 13 or on the first and second substrates 11 and 12.

Besides, in the case of the second substrate having the polarization photo-alignment layer, the manufacturing method further includes a step of forming a polarization photo-alignment layer on the second substrate. In this step, a polymer film (such as a polyimide film) is formed on the second substrate, and then the polymer film is illuminated by a linear, polarized light to become the polarization photo-alignment layer. The wavelength of the linear polarized light is, for example, 254 nm, 313 nm, 365 nm, or their any combinations. The illuminance of the linear polarized light is between 10 mW and 80 mW, the illumination time is between one second and 20 minutes, and the gross energy is between 0.01 J and 10 J, for example.

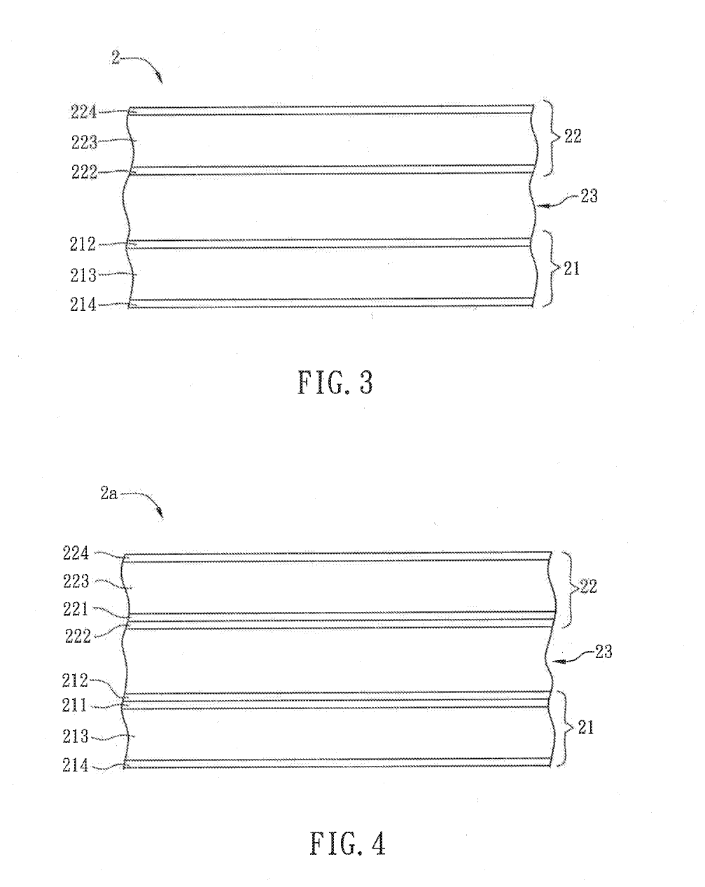

FIG. 3 is a schematic diagram of a liquid crystal display (LCD) panel 2 according to a second embodiment of this disclosure. The LCD panel 2 is not limited in type, which can be a display panel of a fringe field switching (FFS) type, an in-plane switching (IPS) type, or a vertical alignment (VA) type, for example. The LCD panel 2 includes a first substrate 21, a second substrate 22 and a liquid crystal layer 23. The first and second substrates 21 and 22 are disposed oppositely, and the liquid crystal layer 23 is disposed between the first and second substrates 21 and 22. The first and second substrates 21 and 22 are the combination of a color filter (CF) substrate and a thin film transistor (TFT) substrate. Herein for example, the first substrate 21 is a thin film transistor substrate while the second substrate 22 is a color filter substrate. Besides, the LCD panel 2 can have variations according to other technologies. For example, the color filter layer can be disposed to the TFT substrate (i.e. color filter on array, COA), the color filter layer and the black matrix are both disposed to the TFT substrate (i.e. black matrix on array, BOA), or the TFT array is disposed on the CF substrate (i.e. TFT on CF, TOC or array on CF).

The first substrate 21 includes a first photo-induced polymer alignment layer 212. The first photo-induced polymer alignment layer 212 is formed by the polymerization of a plurality of monomers, and these monomers at least include, for example, 4,4′-bisacryloyl-biphenyl group with a chemical structure as follows:

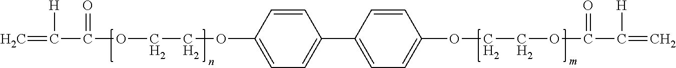

wherein, 0≦m≦5 and 0≦n≦5.

Besides, the monomers can further include another bi-acrylic monomer, which is also one of 4,4′-bisacryloyl-biphenyl group with the chemical structure as follows:

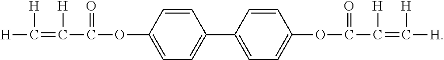

Besides, the monomers can further include another bi-acrylic monomer, which is also one of 4,4′-bisacryloyl-biphenyl group with the chemical structure as follows:

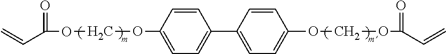

wherein, 1≦m≦7 and 1≦m′≦7.

Besides, the monomers can further include another bi-acrylic monomer, whose chemical name is para-biacryl poly-phenyl group with the chemical structure as follows:

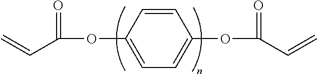

wherein, 1≦n≦5.

Besides, the monomers can further include a tri-acrylic monomer, such as triacryl benzene with the chemical structure as follows:

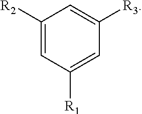

In the above chemical structure, R1=R2=R3=acrylic group, and the chemical structure of R3 is as follows:

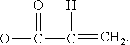

Besides, the first substrate 21 further includes a substrate body 213 and a polarizing element 214. With different types of the LCD panel 2 or applied technologies, the elements included by the substrate body 213 are varied. For example, the substrate body 213 can include a substrate, a TFT array, a pixel electrode layer, etc. The above-mentioned substrate can be a glass substrate, a tempered glass substrate, or a plastic substrate. The polarizing element 214 is attached to a side of the substrate body 213 away from the liquid crystal layer 23. The first photo-induced polymer alignment layer 212 is disposed on a side of the substrate body 213 closer to the liquid crystal layer 23. The first photo-induced polymer alignment layer 212 is disposed between the substrate body 213 and the liquid crystal layer 23, and contacts the liquid crystal layer 23.

The second substrate 22 includes a second photo-induced polymer alignment layer 222. The second photo-induced polymer alignment layer 222 is formed by the polymerization of a plurality of monomers, and these monomers at least include, for example, 4,4′-bisacryloyl-biphenyl group with a chemical structure as follows:

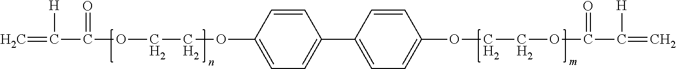

wherein, 0≦m≦5 and 0≦n≦5.

The monomers can further include other kinds of bi-acrylic monomers or tri-acrylic monomers, and their chemical names and structures have been clearly illustrated as above. Moreover, the second substrate 22 further includes a substrate body 223 and a polarizing element 224. With different types of the LCD panel 2 or applied technologies, the elements included by the substrate body 223 are varied. For example, the substrate body 223 can include a transparent substrate, a black matrix, a color filter layer, a common electrode layer, etc. The above-mentioned substrate can be a glass substrate, a tempered glass substrate, or a plastic substrate. The polarizing element 224 is attached to a side of the substrate body 223 away from the liquid crystal layer 23. The second photo-induced polymer alignment layer 222 is disposed on a side of the substrate body 223 closer to the liquid crystal layer 23, and contacts the liquid crystal layer 23.

FIG. 4 is a schematic diagram of LCD panel 2a as a variation according to the embodiment of this disclosure. The first substrate 21 further includes a first rubbing alignment layer 211, which has the same technical feature as the first rubbing alignment layer 111 and therefore they are not described here for concise purpose. The second substrate 21 further includes a second rubbing alignment layer 221, which has the same technical feature as the second rubbing alignment layer 121 and therefore they are not described here for concise purpose. In other embodiments, the first rubbing alignment layer 211 and the second rubbing alignment layer 221 can be respectively replaced by the polarization photo-alignment layers, and since they have been clearly illustrated in the above embodiments, they are not described here for concise purpose.

The manufacturing method of the LCD panel of this embodiment is illustrated as below by taking the LCD panel 2a as an example. First, the first and second substrates 21 and 22 attached and aligned to each other are provided, and a liquid crystal mixture is disposed therebetween. A first rubbing alignment layer 211 is disposed on the first substrate 21, and is formed by the rubbing method wherein a roller is used to rub on a polymer film. A second rubbing alignment layer 221 is disposed on the second substrate 21 and also formed by the rubbing method.

The liquid crystal mixture can be formed between the two substrates by the injection method or the one drop fill (ODF) method. The liquid crystal mixture includes a liquid crystal material and a plurality of monomers, and can further include a photoinitiator in other embodiments. The monomers at least include bi-acrylic monomers, and can further include tri-acrylic monomers or other kinds of monomers in other embodiments. The chemical structures of the monomers and photoinitiator are clearly illustrated as above, and therefore they are not described here for concise purpose. As an example, the monomers have a weight percentage between 0.1% and 1% in the liquid crystal mixture, and preferably they have a weight percentage between 0.2% and 0.5% in the liquid crystal mixture.

Then, when a vertical alignment LCD display is manufactured, an electric filed can be applied to the pixel electrode of the first substrate 21 and the common electrode of the second substrate 22 to tilt the liquid crystal to a required direction. At the same time of applying the electric filed, an illumination is also applied to at least one of the first substrate 21 and second substrate 22. When an LCD display panel of a fringe field switching (FFS) type or of an in-plane switching (IPS) type is manufactured, an illumination is applied to at least one of the first substrate 21 and second substrate 22 while an electric field can not be applied to the pixel electrode of the first substrate 21 and the common electrode of the second substrate 22. The monomers will be polymerized by the illumination, and thus a first photo-induced alignment layer 212 and a second photo-induced alignment layer 222 are formed on the first substrate 21 and the second substrate 22, respectively. Besides, the liquid crystal mixture thus becomes a liquid crystal layer 23. To be noted, some monomers may remain in the liquid crystal layer 23 or on the first and second substrates 21 and 22. Besides, the number and intensity of the illumination and those of applying the electric field are not limited in this embodiment.

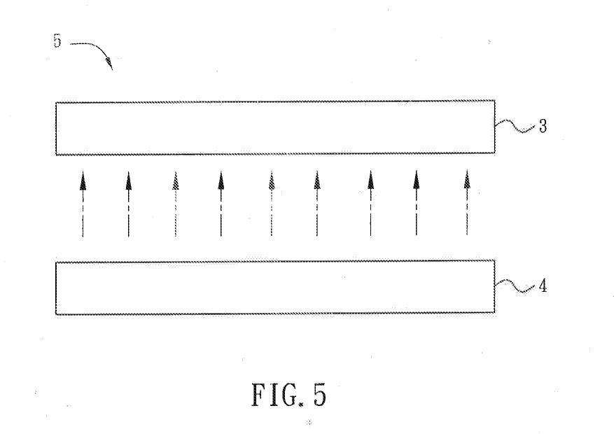

FIG. 5 is a schematic diagram of a liquid crystal display apparatus 5 according to an embodiment of this disclosure. The LCD apparatus 5 includes an LCD panel 3 and a backlight module 4. The LCD panel 3 can be any of the foregoing LCD panels, and is disposed opposite to the backlight module 4 which emits light to the LCD panel 3. In this embodiment, the backlight module 4 is not limited in type, which can be of a direct type or side-edge type.

In summary, in the LCD panel and apparatus according to the embodiments of this disclosure, the first and second photo-induced polymer alignment layers are respectively disposed on the first and second substrates, and are formed by the polymerization of a plurality of monomers. These monomers can make an anchoring effect that can solve the problem of insufficient or unstable alignment of the rubbing alignment layer, so that the image sticking problem is further solved. Besides, the photo-induced polymer alignment layers also can reduce the light leakage problem caused by the rubbing alignment layer. Moreover, the rubbing alignment layer of this disclosure can be made with a slighter depth for the initial arrangement so that the rubbing mura can be reduced. Besides, a kind of monomer is also disclosed with the chemical structure as follows:

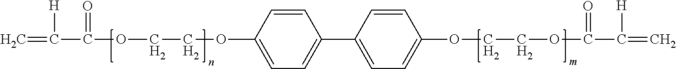

wherein, 0≦m≦5, 0≦n≦5. This kind of monomer can enormously enhance the whole alignment efficiency.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A liquid crystal display panel, comprising:
a first substrate having a first rubbing alignment layer and a first photo-induced polymer alignment layer;
a second substrate disposed opposite to the first substrate and having a second photo-induced polymer alignment layer; and
a liquid crystal layer disposed between the first and second substrates and contacting the first photo-induced polymer alignment layer and the second photo-induced polymer alignment layer.

2. The liquid crystal display panel as recited in claim 1, wherein the first photo-induced polymer alignment layer is disposed between the liquid crystal layer and the first rubbing alignment layer.

3. The liquid crystal display panel as recited in claim 1, wherein the first and second photo-induced polymer alignment layers are both formed by the polymerization of a plurality of monomers.

4. The liquid crystal display panel as recited in claim 3, wherein the monomers include bi-acrylic monomers, tri-arcylic monomers or their combination.

5. The liquid crystal display panel as recited in claim 3, wherein the monomers include monomers of 4,4′-bisacryloyl-biphenyl group with a chemical structure as follows: 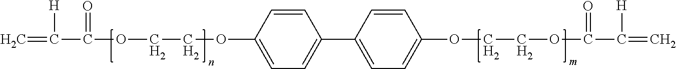
wherein, 0≦m≦5 and 0≦n≦5.

6. The liquid crystal display panel as recited in claim 1, wherein the second substrate further includes a second rubbing alignment layer, and the second photo-induced polymer alignment layer is disposed between the liquid crystal layer and the second rubbing alignment layer.

7. The liquid crystal display panel as recited in claim 1, wherein the second substrate further includes a polarization photo-alignment layer, and the second photo-induced polymer alignment layer is disposed between the liquid crystal layer and the polarization photo-alignment layer.

8. A liquid crystal display panel, comprising:
a first substrate having a first photo-induced polymer alignment layer formed by the polymerization of a plurality of monomers;
a second substrate disposed opposite to the first substrate and having a second photo-induced polymer alignment layer formed by the polymerization of a plurality of monomers; and
a liquid crystal layer disposed between the first and second substrates and contacting the first photo-induced polymer alignment layer and the second photo-induced polymer alignment layer,
wherein the monomers include monomers of 4,4′-bisacryloyl-biphenyl group with a chemical structure as follows: 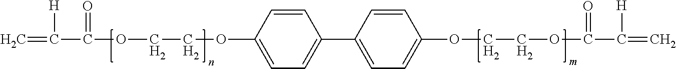
wherein, 0≦m≦5 and 0≦n≦5.

9. The liquid crystal display panel as recited in claim 8, wherein the first substrate further includes a first rubbing alignment layer, and the first photo-induced polymer alignment layer is disposed between the liquid crystal layer and the first rubbing alignment layer.

10. The liquid crystal display panel as recited in claim 8, wherein the first substrate further includes a first polarization photo-alignment layer, and the first photo-induced polymer alignment layer is disposed between the liquid crystal layer and the first polarization photo-alignment layer.

11. The liquid crystal display panel as recited in claim 8, wherein the monomers include bi-acrylic monomers, tri-arcylic monomers or their combination.

12. The liquid crystal display panel as recited in claim 8, wherein the second substrate further includes a second rubbing alignment layer, and the second photo-induced polymer alignment layer is disposed between the liquid crystal layer and the second rubbing alignment layer.

13. The liquid crystal display panel as recited in claim 8, wherein the second substrate further includes a second polarization photo-alignment layer, and the second photo-induced polymer alignment layer is disposed between the liquid crystal layer and the second polarization photo-alignment layer.

14. A liquid crystal display apparatus, comprising:
a backlight module; and
a liquid crystal display panel disposed opposite to the backlight module and comprising:
a first substrate having a first rubbing alignment layer and a first photo-induced polymer alignment layer;
a second substrate disposed opposite to the first substrate and having a second photo-induced polymer alignment layer; and
a liquid crystal layer disposed between the first and second substrates and contacting the first photo-induced polymer alignment layer and the second photo-induced polymer alignment layer.

15. The liquid crystal display apparatus as recited in claim 14, wherein the first photo-induced polymer alignment layer is disposed between the liquid crystal layer and the first rubbing alignment layer.

16. The liquid crystal display apparatus as recited in claim 14, wherein the first and second photo-induced polymer alignment layers are both formed by the polymerization of a plurality of monomers.

17. The liquid crystal display apparatus as recited in claim 16, wherein the monomers include bi-acrylic monomers, tri-arcylic monomers or their combination.

18. The liquid crystal display apparatus as recited in claim 16, wherein the monomers include monomers of 4,4′-bisacryloyl-biphenyl group with a chemical structure as follows: 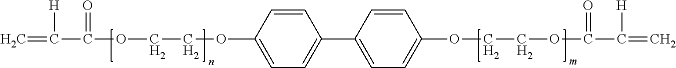
wherein, 0≦m≦5 and 0≦n≦5.
